(19) United States
(12) Patent Application Publication
(10) Pub. No.: US 2010/0172289 A1
(43) Pub. Date: Jul. 8, 2010

(54) METHOD AND DEVICE FOR UTILIZING A CIRCUIT SWITCHED SERVICE IN A PACKET SWITCHED DOMAIN AND COMNUNICATION SYSTEM COMPRISING SUCH DEVICE

(76) Inventors: Harri Kalevi Holma, Helsinki (FI); Juho Pirskanen, Tampere (FI); Antti Anton Toskala, Espoo (FI)

Correspondence Address: STAAS & HALSEY LLP, SUITE 700, 1201 NEW YORK AVENUE, N.W., WASHINGTON, DC, 20005, US

(21) Appl. No.: 12/452,477

(22) PCT Filed: Jun. 19, 2008
(86) PCT No.: PCT/EP2008/057817

§ 371 Date: Mar. 17, 2010

(30) Foreign Application Priority Data
Jul. 2, 2007 (EP) 07012936.6

(51) Int. Cl. H04W 40/00; H04L 12/66

(52) U.S. Cl. 370/328; 370/355

(57) ABSTRACT

A method and a device for utilizing a circuit switched service in a packet switched domain are provided, wherein a mobile terminal is connected to a first network, said first network comprises a first service and a second service, wherein the mobile terminal is connected to the first service of the first network via a first MAC-d flow, said method comprises the steps of (i) at least one second MAC-d flow is set up between the mobile terminal and the second service of the first network; and (ii) at least a connection is set up via the at least one second MAC-d flow.

The invention relates to a method and to a device for utilizing a circuit switched service in a packet switched domain and a communication system comprising such a device.

High-Speed Packet Access (HSPA) is a collection of mobile telephony protocols that extend and improve the performance of existing UMTS protocols.

Standard document 3GPP TR 25.999 (V2.0.0) “3GPP, HSPA Evolution (FDD); (Release 7)” states that HSPA networks will form an integral part of future 3G systems and as they evolve, should provide a smooth migration path towards Long Term Evolution (LTE).

According to document 3GPP TS 23.206 V7.3.0 “3GPP, Voice Call Continuity (VCC) between Circuit Switched (CS) and IP Multimedia Subsystem (IMS); Stage 2 (Release 7)” Voice Call Continuity is a home IP Multimedia System (IMS) application that provides capabilities to transfer voice calls between the CS domain and the IMS. VCC provides functions for voice call originations, voice call terminations and for Domain Transfers between the CS domain and the IMS and vice versa.

However, existing approaches for Voice Call Continuity are not very efficient and often require power consuming channels to be set up further resulting in disadvantageous synchronization efforts by providing such dedicated channels.

The problem to be solved is to overcome the disadvantages as stated before and to provide an approach that allows an efficient transmission and reception of voice calls.

This problem is solved according to the features of the independent claims. Further embodiments result from the depending claims.

In order to overcome this problem, a method for utilizing a circuit switched service in a packet switched domain is provided,
wherein a mobile terminal is connected to a first network,
said first network comprises a first service and a second service,
wherein the mobile terminal is connected to the first service of the first network via a first MAC-d flow.

The method comprises the following steps:
At least one second MAC-d flow is set up between the mobile terminal and the second service of the first network;
at least a connection is set up via the at least one second MAC-d flow.

Hence, this approach installs at least one additional MAC-d flow to the second service of the first network thereby allowing an efficient and fast transfer of data, e.g., a voice call, from the first service to the second service.

MAC-d is the MAC entity that handles the dedicated transport channel (DCH). The MAC-d entity is described, e.g., in 3GPP TS 25.321 V7.4.0 “3GPP, Medium Access Control (MAC) protocol specification (Release 7)”.

In an embodiment, the method comprises the following steps:
information relating to the first MAC-d flow is transferred and/or mapped to the at least one second MAC-d flow;
the first MAC-d flow is released.

Thus, information transferred via the first MAC-d flow for the first service is handed over to the at least one MAC-d flow for the second service. As stated before, the first MAC-d flow as well as the second MAC-d flow may be part of the first network, hence this sort of transfer in particular of call related data can be conducted in a fast and efficient way without having to establish another physical connection that would require signaling efforts and also would lead to an increased power consumption.

In particular, voice packets coming from the packet switched core network may be mapped to the first MAC-d flow. Voice packets coming from the circuit switched core network may be mapped to the at least one second MAC-d flow.

In another embodiment, the connection set up via the at least one second MAC-d flow is a voice connection, in particular a circuit switched call.

In a further embodiment, the first network is a network capable of running a circuit switched (CS) service and a packet switched (PS) service.

This allows the efficient transfer of call-related information from the PS-domain to the CS-domain. Such a transfer can be a preliminary action to a handover to be conducted for the mobile terminal from the first network to a second network, in particular if such second network is only capable of running a circuit switched service (e.g., if the second network is a non-3G network, in particular a non-HSPA network like, e.g., GSM).

Hence, the approach advantageously allows a support of circuit switched services over a packet switched network running, e.g., HSPA. This further enables voice over IP to be mapped and transferred to regular circuit switched calls without any discontinuity.

It is also an embodiment that the first service of the first network is a packet switched service and the second service of the switched network is a circuit switched service. However, it is also possible that the first service of the first network is a circuit switched service and the second service of the switched network is a packet switched service.

This allows any mapping from circuit switched calls to packet switched calls and/or vice versa.

In a next embodiment, the mobile terminal detects a deterioration of its connection to the first network prior to the step of setting up the at least one second MAC-d flow.

The mobile terminal may scan for additional networks and compare a signal strength to the current (here: first) network with signal strength values of further networks. Once, the value of the signal strength to the current network is below a certain threshold and/or a value of a signal strength to a new (here: second) network is above a certain threshold, the mobile terminal could initiate a handover from the first network to the second network (such a handover may in particular be network controlled and mobile assisted).

However, if the second network, e.g., only supports circuit switched calls whereas the mobile terminal actually is connected to the first network processing packet switched calls via, e.g., HSPA, a transfer from the packet switched domain to the circuit switched domain may be processed as described herein prior to the actual handover proceedings from the first network to the second network.

It is to be noted that it could be indicated by either the mobile terminal (UE) or by the RNC (Radio Network Controller) functionality of the (core) network (RAN) whether a domain change from the PS domain to the CS domain or vice versa is desirable and/or possible.

It is also an embodiment that the method comprises the step:
a handover is conducted to a second network comprising a third service.

Thus, a handover from the first to the second network can be initiated after the transfer from the packet switched domain to the circuit switched domain has been conducted in the first network.

Pursuant to another embodiment, the third service is a circuit switched service.

In case the second network does not support packet switched services, the first network prior to the handover to the second network transferred the call from the packet switched domain to the circuit switched domain via MAC-d flows as described. Then, the handover from the first network to the second network can process calls of the circuit switched domain only.

According to an embodiment, the mobile terminal is a user equipment. The mobile terminal may further be any kind of device comprising a 3G radio unit like, e.g., a palm computer or a laptop computer with a 3G interface.

According to another embodiment, the first network is a 3G network that is in particular capable of high speed packet access (HSPA).

In yet another embodiment, the method as described herein is run on a device comprising a RNC functionality. This may in particular be a network component providing at least a portion of such RNC functionality.

According to a next embodiment, said RNC functionality may be distributed among several device, in particular among several network components.

Pursuant to yet an embodiment, the method as described may utilize voice over IP calls and/or circuit switched phone calls.

It is also an embodiment that Radio Access Bearer (RAB) flows may be differentiated by utilizing at least one of the following means:
Packet sizes;
Logical channel ID;
Packet Data Convergence Protocol (PDCP) layer by utilizing Packet Identifier (PID) fields of a PDCP header.

The problem stated supra is also solved by a device for utilizing a circuit switched service in a packet switched domain comprising a processor unit that is arranged and/or equipped such that the method as described herein is executable on said processor unit.

According to an embodiment, the device is a communication device, in particular a network component comprising (at least a portion of) a RNC functionality.

Also, the problem stated above is solved by a communication system comprising the device as described herein.

Embodiments of the invention are shown and illustrated in the following figures:

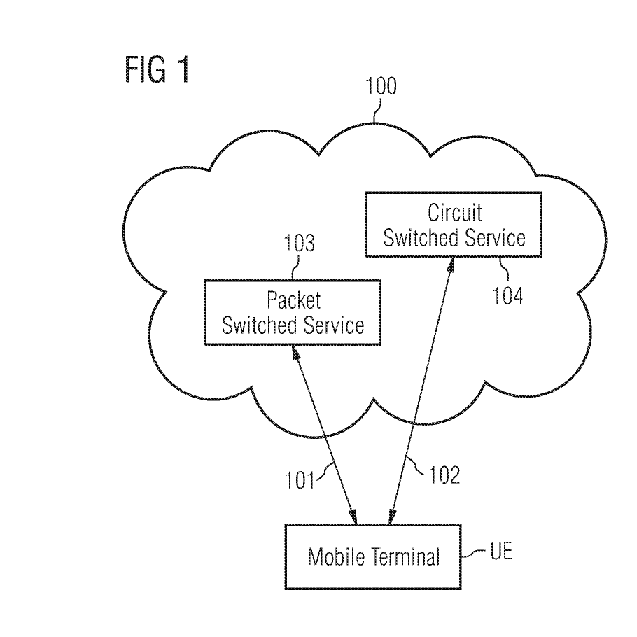

FIG. 1 shows an environment comprising a network and a mobile terminal, the network providing a packet switched service and a circuit switched service, wherein the mobile terminal is connected via MAC-d flows;

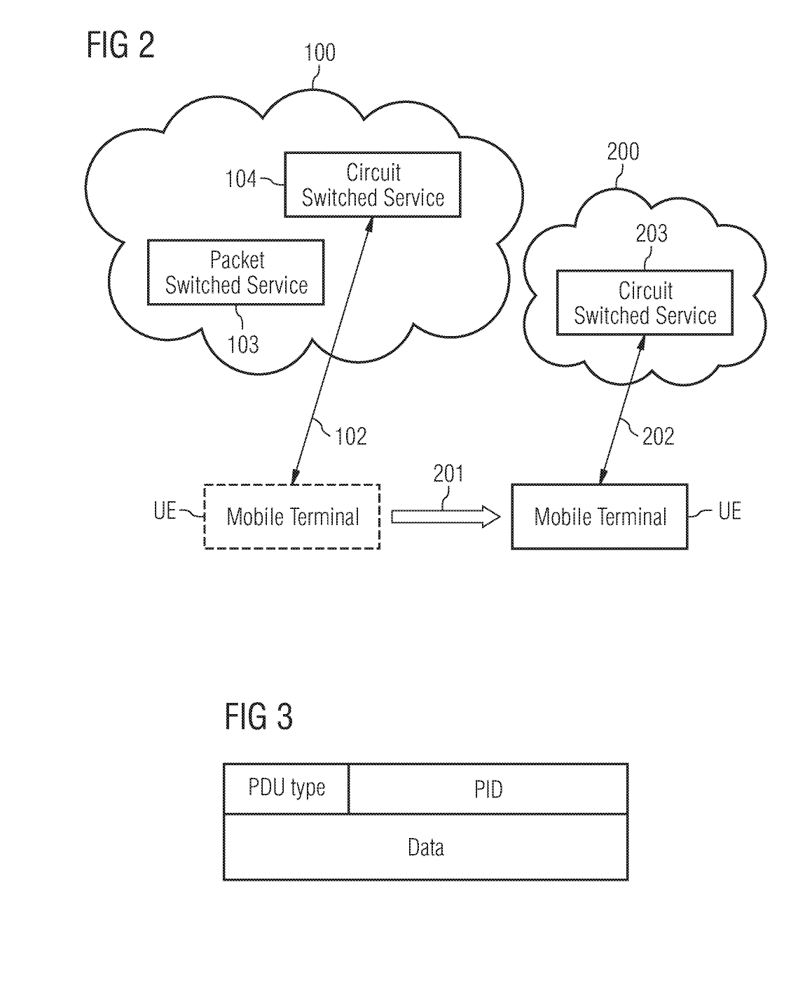

FIG. 2 shows based on the environment according to FIG. 1 a scenario comprising an additional network providing only a circuit switched service, wherein the mobile terminal performs a handover from the first network to the second network;

FIG. 3 shows a table visualizing a PDCP Data PDU format according to 3GPP TS 25.323.

This approach relates in particular to a handling Voice Call Continuity (VCC) and running circuit switched (CS) services over high speed packet access (HSPA). It suggests an efficient solution as how to switch in particular from voice over IP (VoIP) to a regular circuit switched (CS) call in case a coverage of the VoIP capable network is lost, e.g., if the mobile terminal, in particular a user equipment (UE), moves to cells without HSPA support or to cells supporting GSM only.

The solution presented advantageously avoids the need for setting up dedicated channels in parallel, which would reduce a power available for high speed downlink packet access (HSDPA). Furthermore, the approach provided herewith allows a fast transfer from packet switched services to circuits switched services.

The approach as set forth suggests to perform a transfer from the packet switched (PS) service to the circuit switched (CS) service using at least one additional MAC-d flow (in particular using multiple MAC-d flows) for the circuit switched traffic as well as for the packet switched traffic. The at least one additional MAC-d flow is utilized for a single user, in particular for a mobile terminal that is advantageously a user equipment (UE).

Based on the MAC-d flows a mapping is conducted transferring the circuit switched service, e.g., an adaptive multi-rate (AMR) speech call, to a high speed downlink packet access (HSDPA) and/or to a high speed uplink access (HSUPA).

In addition, it is also possible to perform a transfer from the circuit switched service to the packet switched service.

Advantageously, the AMR speech call as a circuit switched service may be mapped in an unacknowledged mode of a Radio Link Control (RLC) protocol (see, e.g., 3GPP TS 25.322, V7.2.0, Technical Specification Group Radio Access Network; Radio Link Control (RLC) protocol specification). Furthermore, ciphering may be performed in the RLC layer.

FIG. 1 shows a scenario comprising a first network 100 that is capable of processing a Packet Switched Service 103 and a Circuit Switched Service 104. A Mobile Terminal UE is processing a voice call via a MAC-d flow 101 that is connected with the Packet Switched Service 103. In particular, this voice call processed may be a voice over IP (VoIP) telephone call.

The first network 100 and/or the Mobile Terminal UE may recognize a deterioration of a signal strength relating to the connection between the Mobile Terminal UE and the first network 100. The Mobile Terminal UE may scan for further networks to be connected to. If such a further network found only supports circuit switched services, the current call is transferred from the Packet Switched Service 103 to the Circuit Switched Service 104 by setting up at least one additional MAC-d flow 102 in parallel to the existing MAC-d flow 101. The circuit switched call is set up via this at least one additional MAC-d flow 102 (i.e. transferred from the Packet Switched Service 103) and subsequently the MAC-d flow 101 may be terminated.

As a next step, as visualized in FIG. 2, the mobile terminal may move to the coverage of a second network 200 that may be a GSM network not providing any HSPA services (indicated by only comprising a Circuit Switched Service 203). A handover 201 is conducted from the Circuit Switched Service 104 of the first network 100 to the Circuit Switched Service 203 of the second network 200. A MAC-d flow 202 may be set up to carry the call between the Mobile Terminal UE and the second network 200.

A separation of the downlink and in particular of the uplink Radio Access Bearer (RAB) sub-flows utilized by AMR circuit switched voice traffic can be used for unequal error protection with positive effects regarding the performance. Another advantage is a separation of different RABs so that circuit switched voice service can remain unchanged. According to document 3GPP, TS 34.108, Common test environments for User Equipment (UE), Conformance testing, AMR voice may use two or three different RAB sub-flows. Such separation may in particular be based on one following options:
Packet sizes, as received by the user equipment UE and/or by the Radio Network Controller (RNC) as each sub-flow may provide a different set of packets;
Logical channel ID, so that each RAB sub-flow would be mapped to a separate logical channel utilizing a UM-RLC (RLC, unacknowledged mode) entity; each logical channel could be mapped to the same MAC-d flow;
Packet Data Convergence Protocol (PDCP) layer by utilizing Packet Identifier (PID) fields of the PDCP header as shown in table of FIG. 3. PID values 15 . . . 31 may be used as RAB sub-flows (see also 3GPP TS 25.323 V7.4.0, Packet Data Convergence Protocol (PDCP) specification).

A similar solution may be applied for narrowband AMR or for wideband AMR.

In case of wideband AMR the SRB#5 (Signaling Radio Bearer) utilized for rate control can also be mapped to HSPA according to the scheme as set forth above.

Further, circuit switched data services may utilize this scheme if needed.

The approach provided bears in particular the following advantages:
a) The circuit switched services can be processed as new services on HSPA; hence, the services can be handled in a similar fashion, although they may not be multiplexed within the same MAC-d flow.
b) No changes are required for the circuit switched core network. Hence, the circuit switched core network may not have to be aware whether a particular connection is mapped via DCH or on HSPA.
c) The VoIP call continuity is improved by supporting AMR over HSPA.
d) Problems related to DL code and power blocking are solved.
e) AMR voice capacity is increased by all features introduced in continuous packet connectivity that may in particular be utilized via VoIP mechanisms.
f) The power consumption of the user equipment for AMR circuit switched voice calls is improved by providing discontinuous transmission and reception.
g) Faster call setup time is realized since the core network (NAS) signaling is running via HSPA.
h) A flexibility of the system is increased by providing the possibility to add parallel packet switched services together with, e.g., a circuit switched voice call. This may in particular be useful with regard to real-time video sharing and/or video streaming applications.

1. A method for utilizing a circuit switched service in a packet switched domain,
wherein a mobile terminal is connected to a first network,
said first network comprises a first service and a second service,
wherein the mobile terminal is connected to the first service of the first network via a first MAC-d flow;
the method comprising the following steps:
at least one second MAC-d flow is set up between the mobile terminal and the second service of the first network;
at least a connection is set up via the at least one second MAC-d flow.

2-18. (canceled)
